(19) United States
(12) Patent Application Publication
(10) Pub. No.: US 2011/0159174 A1
(43) Pub. Date: Jun. 30, 2011

(54) RECYCLING USING MAGNETICALLY-SENSITIVE PARTICLE DOPING

(75) Inventor: Manibrata Paul, Kolkata (IN)

(73) Assignee: ENVIRONTICS, VILL., Howrah (IN)

(21) Appl. No.: 12/706,493

(22) Filed: Feb. 16, 2010

(30) Foreign Application Priority Data
Dec. 30, 2009 (IN) 1492/KOL/2009

(51) Int. Cl. B05D 5/12; B05C 19/00

(52) U.S. Cl. 427/128; 118/308

(57) ABSTRACT

A doping gun may be used to dope the coating layer of a bonded material with magnetically-sensitive particles. During a recycling process, pieces of the coating layer may be magnetically separated from non-doped pieces of the bonded material. In this way, the non-doped pieces are of a relatively high purity level. Then, these non-doped pieces can be recycled with an improved yield.

### CROSS REFERENCE TO RELATED APPLICATIONS

This application claims priority to Indian Patent Application Serial No. 1492/KOL/2009 filed Dec. 30, 2009, the contents of which are incorporated by reference herein in its entirety.

### BACKGROUND

Recycling coated plastics, such as thermoplastics, with a recovery of the plastic resin in its original form, is a global problem. If the coating is not removed during recycling process, it is very difficult to recycle such plastics without degrading quality. In particular, composition of the coating may be different from the plastic substance, and may contaminate the plastics substrate material. As a result, the coating degrades the purity of the plastic resin and restricts its use.

Traditional processes to remove coatings from plastics are mostly chemical in nature and are not satisfactory because of such problems. Current chemical processes can be cost-prohibitive and may also degrade the polymer quality of the substrate. A considerable amount of coated plastic is not recycled at all because the recovered material has a very low value that cannot justify the cost of the recycling process.

### SUMMARY

Methods and devices for doping a bonded material are presented. The bonded material may comprise a coating layer adhered to the surface of a plastic substrate. In particular, a technique to introduce magnetically-sensitive particles in the coating layer is described herein. This technique serves to reduce the contamination of plastics from coating materials during a recycling process. By injecting these magnetically-sensitive particles into the coating layer, the material of the coating layer becomes sensitive to magnetic force and can be more easily separated from the plastic substrate.

In a first embodiment, a doping gun for injecting magnetically-sensitive particles, such as iron, into a bonded material is introduced. The doping gun may comprise a hopper for holding the magnetically-sensitive particles, a tube for receiving a flow of a gas, and a barrel. The barrel may include a first end, coupled to the hopper and the tube, that receives the magnetically-sensitive particles and the flow of the gas. The barrel may also include a second end from which the magnetically-sensitive particles are expelled. The doping gun may further comprise a regulator, coupled to the hopper and the barrel, for controlling delivery of the magnetically-sensitive particles from the hopper into the barrel, as well as a trigger for controlling the flow of gas from the tube into the barrel.

The hopper may optionally include a heating mechanism to heat the magnetically-sensitive particles. This heating mechanism may include, for example, a heating coil, thermostatic heater, or a similar device that can heat the magnetically-sensitive particles to a temperature above that of the bonded material. The exact temperature to which the magnetically-sensitive particles are heated may vary, and may be based on the composition and thickness of the coating layer and/or the plastic substrate.

The tube may be coupled to a source of compressed gas that is used to supply the flow of gas. This gas, for example, may be air. The flow of gas may force the magnetically-sensitive particles into the coating layer of the bonded material so that the majority of the magnetically-sensitive particles introduced into the bonded material populate the coating layer rather than the plastic substrate.

In a second embodiment, the doping gun may be used for injecting magnetically-sensitive particles into the bonded material. To do so, an end of the doping gun barrel may be aligned substantially perpendicular to the coating layer of the bonded material. Then, the magnetically-sensitive particles may be released from the hopper, and the flow of the gas may be released from the tube, thereby introducing the magnetically-sensitive particles into the bonded material.

In a third embodiment, the doping gun may be used for distributing magnetically-sensitive particles onto the surface of the plastic substrate prior to the coating layer being applied. In this way, the application of the coating layer may serve to introduce the magnetically-sensitive particles into the coating layer.

Any of these embodiments can be combined with a recycling process wherein the bonded material is disintegrated to flakes. Flakes containing part of a coating layer doped with magnetically-sensitive particles can be detected and separated from the flakes that do not contain any magnetically-sensitive particles. For instance, an electromagnetic separator may be used to direct doped flakes into a first stockpile, while un-doped flakes are directed into a second stockpile. In doing so, flakes containing the coating layer are separated from flakes containing the plastic substrate, thus enabling the plastic substrate to be recycled with a higher purity and at a greater yield.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a depiction of a plastic substrate with a coating layer that is doped with magnetically-sensitive particles in accordance with an example embodiment;

FIG. 2 is a depiction of magnetically-sensitive particles being injected into a coating layer in accordance with an example embodiment;

FIG. 3 is a depiction of a recycling process in accordance with an example embodiment;

FIG. 4 is another depiction of a recycling process in accordance with an example embodiment;

FIG. 5 is a depiction of a doping gun in accordance with an example embodiment; and

FIG. 6 is a flow chart in accordance with an example embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

For instance, throughout the embodiments herein, the term “plastic” may refer to any form of plastic, including but not limited to thermoplastics, thermosoftening plastics, or other types of polymers. Additionally, the term “magnetically-sensitive particles” may refer to any type of particle capable of interacting with a magnet, including but not limited to ferromagnetic particles such as iron particles. Moreover, the term “substantially perpendicular” may refer to an alignment of objects not necessarily just at a ninety-degree angle, but at any angle sufficient to perform the doping described herein.

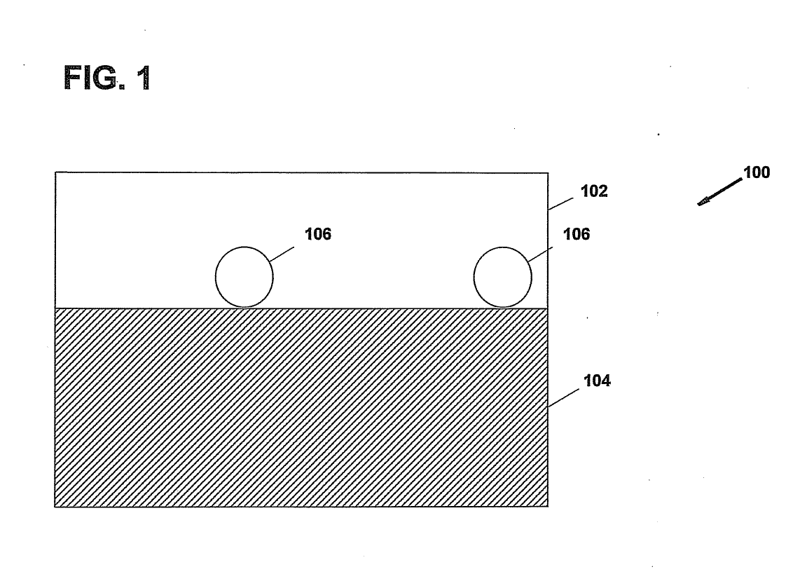

To facilitate improved recycling of coated plastics, a doping process is presented. As shown in FIG. 1, a bonded material 100 may comprise a coating layer 102 and a substrate layer 104. Substrate layer 104 may be a plastic, such as a thermoplastic. Depending on the application for which they are used, engineered plastics, including thermoplastics, may be coated with another polymer. This coating layer may enhance a certain characteristic such as texture, color, longevity, or stability when exposed to ultraviolent light or oxygen. Thus, coating layer 102 may comprise any material sufficient to serve one or more of these purposes. For instance, coating layer 102 may be an inorganic coating applied via plasma enhanced vapor deposition methods, a thermally cured silicone hard coat, an ultraviolet cured vinyl acrylate, or a highly cross-linked polyurethane thermoset resin. Epoxy thermosets or polyurethane and/or melamine type coatings may also be used.

In one embodiment, substrate layer 104 is thicker than coating layer 102. Substrate layer 104 may be of a material that is readily recyclable, while coating layer 102 may be of a material not as readily recyclable. Thus, if bonded material 100 is recycled as a whole, coating layer 102 may introduce impurities into the recycling process that may reduce the useful yield of this process.

In order to improve the recycling yield of bonded material 100, magnetically-sensitive particles 106, such as iron particles, may be introduced into bonded material 100. Magnetically-sensitive particles 106 may be injected into coating layer 102 by a doping gun, so that a majority of magnetically-sensitive particles 106 come to reside in coating layer 102. Alternatively, the doping gun may be used for distributing magnetically-sensitive particles onto the surface of the plastic substrate prior to the coating layer being applied. Such doping processes may occur just one time, or several times.

Then, during a recycling process, bonded material 100 can be crushed, ground or otherwise disintegrated into flakes. Flakes doped with magnetically-sensitive particles 106 can be magnetically separated from flakes without magnetically-sensitive particles 106. Since a majority of flakes doped with magnetically-sensitive particles 106 will be flakes containing coating layer 102, this process will reduce recycling impurities and improve the recycling yield of bonded material 100.

Magnetically-sensitive particles 106 may be substantially smaller in diameter than coating layer 102, so that they do not affect the appearance of coating layer 102, but still get distributed into coating layer 102. Since coating layer 102 may be in direct contact with substrate layer 104 over most of its surface region, coating layer 102 may remain adhered to substrate layer 104 despite the introduction of magnetically-sensitive particles 106.

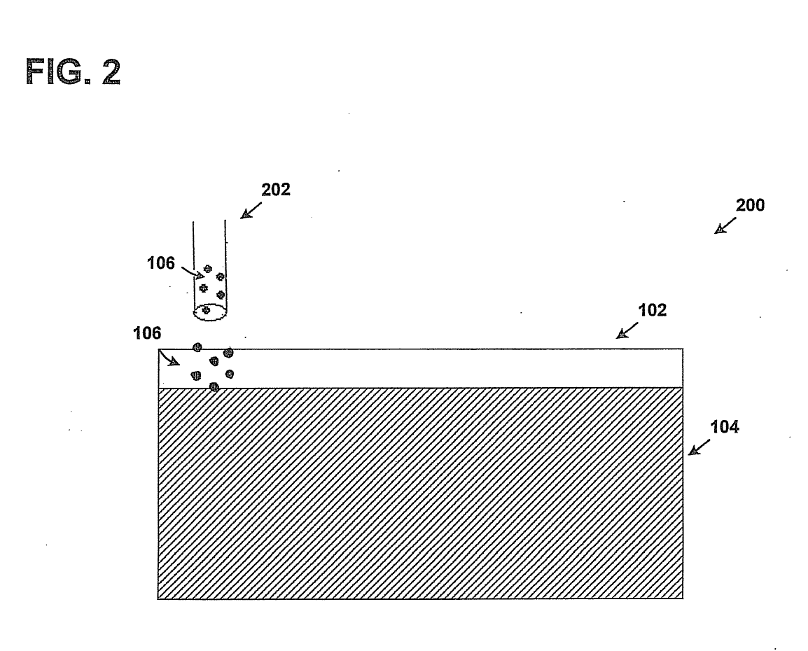

Magnetically-sensitive particles 106 may be introduced into bonded material 100 by a doping gun. FIG. 2 illustrates an arrangement 200 of the barrel of a doping gun 202 aligned to be substantially perpendicular to coating layer 102. Doping gun 202 may inject magnetically-sensitive particles 106 into coating layer 102. To do so, doping gun 202 may fire magnetically-sensitive particles 106 into coating layer 102 using pressure from a pneumatic, hydraulic, or another mechanism that imparts sufficient velocity so that magnetically-sensitive particles 106 penetrate coating layer 102.

Optionally, magnetically-sensitive particles 106 may be heated, in order to facilitate their penetration into coating layer 102. Alternatively, bonded material 100 may be heated, or otherwise softened, to facilitate the entry of magnetically-sensitive particles 106. Regardless of whether magnetically-sensitive particles 106, bonded material 100, or both are heated, doping gun 202 may propel magnetically-sensitive particles 106 with sufficient momentum to pierce coating layer 102. Doping gun 202 may be aligned with various points of the surface of coating layer 102 so that most or all of coating layer 102 is doped.

Ideally, magnetically-sensitive particles 106 are propelled in such a way that they penetrate coating layer 102, and most stop before reaching the junction between coating layer 102 and substrate layer 104. The momentum and temperature required for such an effect may be dependent on the composition and thickness of coating layer 102, and doping gun 202 may be arranged to take these factors into account. Thus, doping gun 202 may be calibrated or programmed with various parameters to control the momentum and temperature of magnetically-sensitive particles 106.

For instance, the kinetic energy of magnetically-sensitive particles 106 expelled from doping gun 202 may be expressed by the equation K=½ mv², where K is kinetic energy, m is mass, and v is velocity. The thermal energy of such a particle may be given by the equation Q=mst, where Q is thermal energy, m is mass, s is specific heat, and t is temperature. While doping gun 202 may be operated with consideration of these equations, it should be understood that doping gun 202 may also operate according to other configurations, equations, or parameters. Furthermore, these equations need not explicitly be taken into account during the design or operation of doping gun 202.

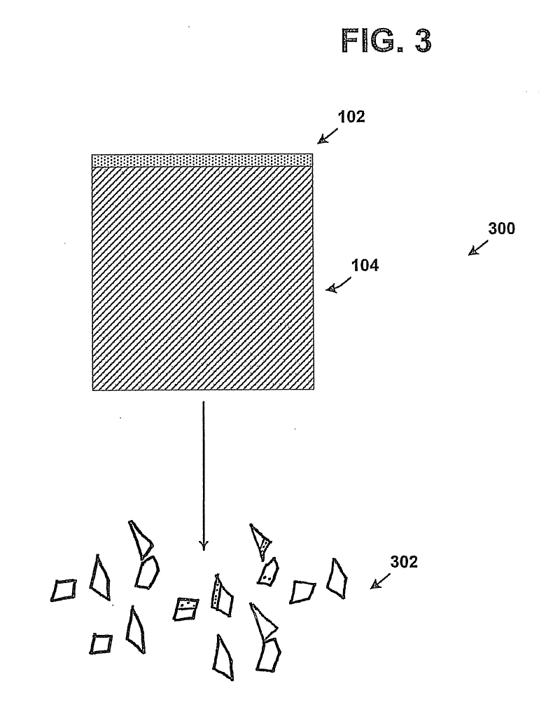

FIG. 3 illustrates bonded material 100 being subjected to grinding and disintegration into flakes 302. This grinding process can occur according to any technique now known or used in the future with respect to recycling plastics. Flakes 302 containing any part of coating layer 102 are very likely to also contain at least some of the doped magnetically-sensitive particles 106 as well. Flakes 302 that are of substrate material 104 only will likely not contain any magnetically-sensitive particles 106 and hence, will not be susceptible to magnetic force.

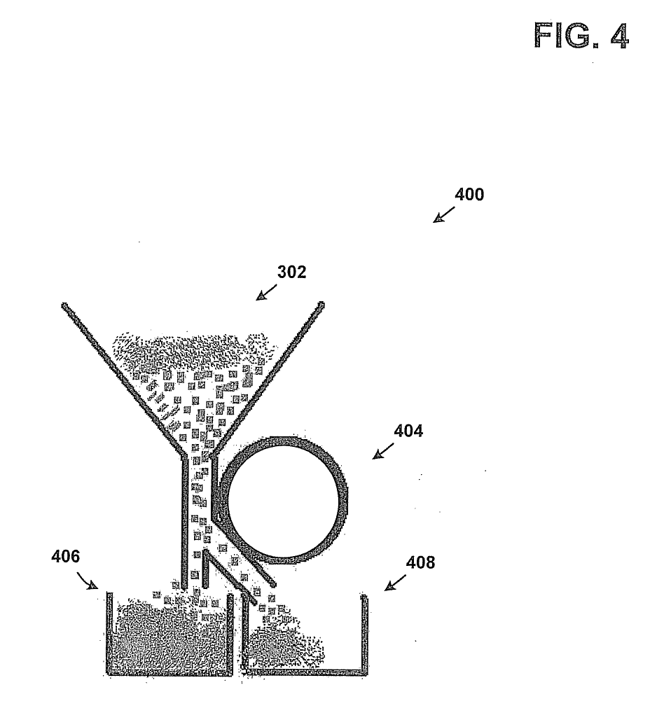

FIG. 4 illustrates flakes 302 being subjected to magnetic separation. The separation may be accomplished by passing flakes 302 near the influence of magnet 404. It should be understood that magnet 404 may be any type or form of magnet. For instance, magnet 404 may be an electromagnet. As a result of the influence of magnet 404, flakes 302 may be separated into two different stockpiles. Stockpile 408 may contain materials that are sensitive to a magnetic field, and stockpile 406 may contain materials that are not sensitive to a magnetic field.

Since coating layer 102 of bonded material 100 is doped with magnetically-sensitive particles 106, flakes that contain pieces of coating layer 102 may be deposited in stockpile 408. Conversely, since most of substrate layer 104 of bonded material 100 should be devoid of magnetically-sensitive particles 106, flakes containing only substrate layer 104 may be substantially devoid of magnetically-sensitive particles 106. Therefore flakes containing only substrate layer 104 may be deposited in stockpile 406. Once separated in this way, flakes in stockpile 406 can be recycled in any appropriate fashion. This recycling process may result in an improved yield due to the purity of the flakes in stockpile 406.

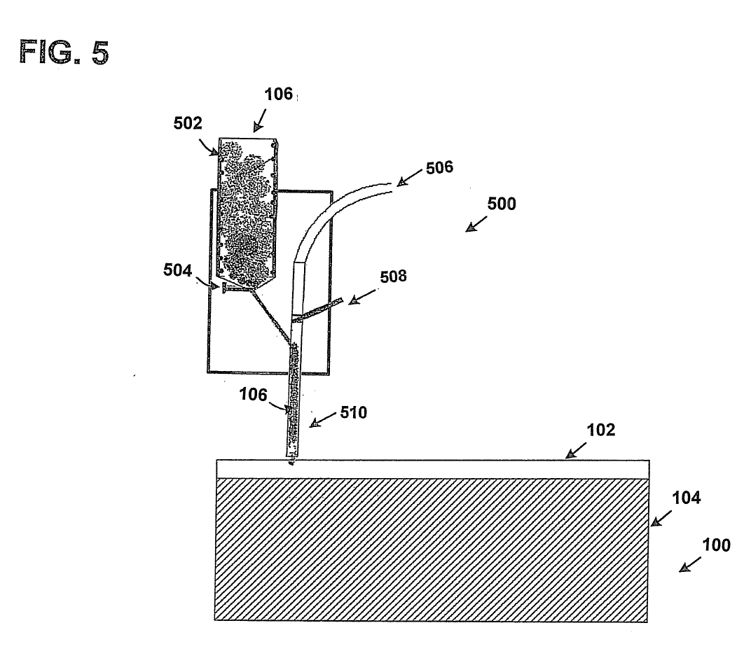

FIG. 5 illustrates a functional diagram of doping gun 500 for injecting magnetically-sensitive particles 106 into bonded material 100. The principle of doping gun 500 may be similar to that of an air gun, in that a flow of gas may be used to propel magnetically-sensitive particles 106 into coating layer 102 of bonded material 100. Alternatively, doping gun 500 may operate using pressure from a pneumatic, hydraulic, or another mechanism that imparts sufficient velocity so that magnetically-sensitive particles 106 penetrate coating layer 102. Doping gun 500 may also be used for distributing magnetically-sensitive particles 106 onto the surface of the substrate layer 104 prior to coating layer 102 being applied.

Doping gun 500 may comprise hopper 502 for holding the magnetically-sensitive particles 106, tube 506 for receiving a flow of a gas, and barrel 510. Hopper 502 may be any type of chamber suitable for holding magnetically-sensitive particles 106 in accordance with the embodiments herein. Barrel 510 may include a first end coupled to hopper 502 and tube 506, for receiving magnetically-sensitive particles 106 and the flow of the gas, and a second end from which magnetically-sensitive particles 106 are expelled into coating layer 102 of bonded material 100. Doping gun 500 may further comprise regulator 504, coupled to hopper 502 and barrel 510, for controlling delivery of magnetically-sensitive particles 106 from hopper 502 into barrel 510. Hopper 502 may be oriented to allow the pull of gravity to introduce magnetically-sensitive particles 106 from hopper 502 into barrel 510.

Hopper 502 may optionally include a heating mechanism to heat the magnetically-sensitive particles 106. This heating mechanism may comprise, for example, a heating coil, thermostatic heater, or similar device that can heat magnetically-sensitive particles 106 to a temperature above that of bonded material 100. The exact temperature to which the magnetically-sensitive particles 106 are heated may vary, and may be based on the composition and thickness of coating layer 102. Doping gun 500 may be arranged to allow this temperature to be adjusted either automatically or by a human.

Tube 506 may be coupled to a source of compressed gas that is used to supply the flow of gas. This gas, for example, may be air. The supply of gas may force magnetically-sensitive particles 106 into coating layer 102 of the bonded material 100 so that the majority of magnetically-sensitive particles 106 introduced into bonded material 100 populate the coating layer 102 rather than the substrate layer 104. The pressure of the gas may be based on the composition and thickness of coating layer 102.

Doping gun 500 may additionally comprise trigger 508, coupled to tube 506 and barrel 510, for controlling the flow of gas from tube 506 into barrel 510. In one configuration, trigger 508 may close an orifice between tube 506 and barrel 510, thereby turning off doping gun 500. In other configurations, trigger 508 may serve to open the orifice to one or more widths, thereby turning on doping gun 500 and controlling the rate at which magnetically-sensitive particles 106 are fired.

When regulator 504 is configured to allow magnetically-sensitive particles 106 to enter barrel 510, and trigger 508 has opened the orifice between tube 506 and barrel 510, the flow of gas from tube 506 may propel magnetically-sensitive particles 106 out of barrel 510. The inertia from this propelling may serve to inject the propelled particles into an adjacent material.

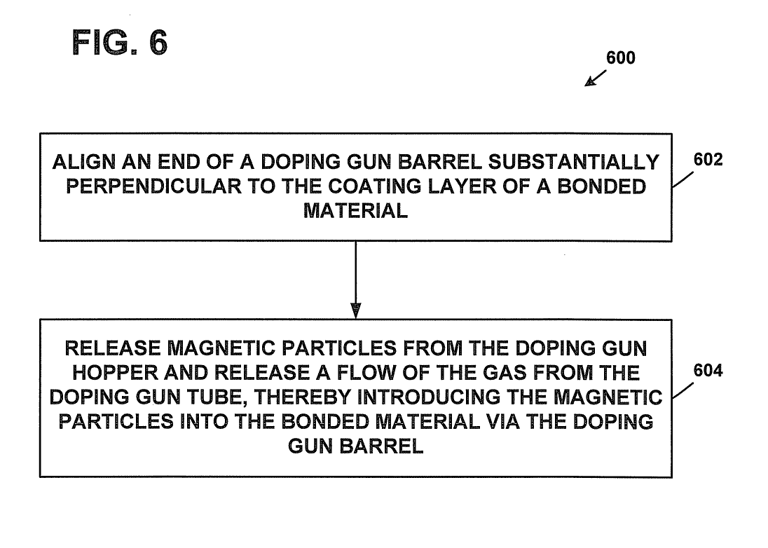

FIG. 6 is a flow chart of a method 600 that illustrates the doping process. At step 602, an end of a doping gun barrel is aligned to be substantially perpendicular to the coating layer of a bonded material. The doping gun may be arranged according to the illustration in FIG. 5, in that it may comprise a hopper for holding the magnetically-sensitive particles, a tube for receiving a flow of a gas, and a barrel for combining the magnetically-sensitive particles with the flow of gas, and releasing this combination with force from the doping gun. The bonded material may comprise a coating layer adhered to a substrate layer.

At step 604, the doping gun may release magnetically-sensitive particles from the hopper and release the flow of gas from the tube, thereby combining the magnetically-sensitive particles with the flow of gas. This combination may then be expelled with force via the barrel and into the coating layer of the bonded material.

It should be understood that the doping gun may also comprise a regulator, coupled to the hopper and the barrel, for controlling delivery of the magnetically-sensitive particles from the hopper into the barrel. Additionally, the doping gun may comprise a trigger for controlling the flow of gas from the tube into the barrel.

The hopper may optionally contain a heating mechanism to heat the magnetically-sensitive particles. This heating mechanism may include, for example, a heating coil, a thermostatic heater, or a similar device that can heat the magnetically-sensitive particles to a temperature above that of the bonded material. The exact temperature to which the magnetically-sensitive particles are heated may vary, and may be based on the composition and thickness of the coating layer.

The tube may be coupled to a source of compressed gas that is used to supply the flow of gas. This gas, for example, may be air. The supply of gas may force the magnetically-sensitive particles into the coating layer of the bonded material so that the majority of the magnetically-sensitive particles introduced into the bonded material populate the coating layer rather than the plastic substrate. The pressure of the gas may be based on the composition and thickness of coating layer 102 and/or plastic substrate 104. Additionally, the compressed gas may be driven by a pneumatic, hydraulic, or another mechanism that imparts sufficient velocity so that magnetically-sensitive particles 106 penetrate coating layer 102.

It should be understood that the methods, procedures, operations, devices, and systems illustrated in FIGS. 1-6 may be modified without departing from the spirit of the invention. For example, these methods, procedures, operations, devices, and systems may comprise more or fewer steps or components than appear herein, and these steps or components may be combined with one another, in part or in whole.

Furthermore, the present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A doping gun for introducing magnetically-sensitive particles into a material, the doping gun comprising:
a hopper for holding the magnetically-sensitive particles;
a tube for receiving a flow of a gas; and
a barrel, including:
a first end coupled to the hopper and the tube, for receiving the magnetically-sensitive particles and the flow of the gas, and a second end from which the magnetically-sensitive particles are expelled into the material.

2. The doping gun of claim 1, further comprising a regulator, coupled to the hopper and the barrel, for controlling delivery of the magnetically-sensitive particles from the hopper into the barrel.

3. The doping gun of claim 1, further comprising a trigger for controlling the flow of gas from the tube into the barrel.

4. The doping gun of claim 1, wherein the hopper contains a heating mechanism to heat the magnetically-sensitive particles.

5. The doping gun of claim 4, wherein the heating mechanism comprises a heating coil.

6. The doping gun of claim 4, wherein the magnetically-sensitive particles are heated to a temperature above that of the material.

7. The doping gun of claim 6, wherein the temperature is determined based on a composition and a thickness of at least part of the material.

8. The doping gun of claim 1, wherein the material is a bonded material comprising a coating layer joined to a surface of a plastic substrate, and wherein the magnetically-sensitive particles are expelled into the coating layer of the bonded material.

9. The doping gun of claim 8, wherein a majority of the magnetically-sensitive particles expelled into the bonded material populate the coating layer.

10. The doping gun of claim 1, wherein the tube is coupled to a source of compressed gas, the compressed gas forming a supply of the flow of the gas.

11. A method for doping a bonded material, wherein the bonded material comprises a coating layer adhered to a surface of a plastic substrate, wherein a doping gun introduces magnetically-sensitive particles into the bonded material, wherein the doping gun comprises (i) a hopper for holding the magnetically-sensitive particles, (ii) a tube for receiving a flow of a gas, and (iii) a barrel, including a first end coupled to the hopper and the tube for receiving the magnetically-sensitive particles and the flow of the gas, and a second end from which the magnetically-sensitive particles are expelled into the coating layer of the bonded material, the method comprising:
aligning the second end of the barrel substantially perpendicular to the coating layer; and
releasing the magnetically-sensitive particles from the hopper and releasing the flow of the gas from the tube, thereby introducing the magnetically-sensitive particles into the bonded material.

12. The method of claim 11, wherein the doping gun further comprises a regulator, coupled to the hopper and the barrel, for controlling release of the magnetically-sensitive particles from the hopper into the barrel.

13. The method of claim 11, wherein the doping gun further comprises a trigger, for controlling the release of the flow of gas from the tube into the barrel.

14. The method of claim 11, wherein the hopper contains a heating mechanism to heat the magnetically-sensitive particles.

15. The method of claim 14, wherein the heating mechanism comprises a heating coil.

16. The method of claim 14, wherein the magnetically-sensitive particles are heated to a temperature above that of the bonded material.

17. The method of claim 16, wherein the temperature is determined based on a composition of the coating layer and a thickness of the coating layer.

18. The method of claim 11, wherein the magnetically-sensitive particles comprise iron.

19. The method of claim 11, wherein the tube is coupled to a source of compressed gas, the compressed gas forming a supply of the flow of the gas.

20. The method of claim 11, wherein a majority of the magnetically-sensitive particles introduced into the bonded material populate the coating layer.
